(19) United States
(12) Patent Application Publication
(10) Pub. No.: US 2024/0430512 A1
(43) Pub. Date: Dec. 26, 2024

(54) USE OF SENSED PASSENGER PARAMETERS FOR MANAGEMENT AND CONTROL OF MEDIA IN A TRANSPORT CRAFT

(71) Applicant: VIASAT, INC., Carlsbad, CA (US)

(72) Inventor: Vijay A. SURYAVANSHI, Mumbai (IN)

(21) Appl. No.: 18/827,602

(22) Filed: Sep. 6, 2024

Related U.S. Application Data
(63) Continuation of application No. PCT/US2022/019388, filed on Mar. 8, 2022.

(51) Int. Cl. H04N 21/414; H04N 21/258; H04N 21/4363

(52) U.S. Cl. CPC H04N 21/41422; H04N 21/25883; H04N 21/43637

(57) ABSTRACT

Management of media content delivery on a transport craft based on a sensed passenger parameter. The sensed passenger parameter is generated based on sensing of a network access point. The passenger parameter may be communicated to an on-board content management system (CMS) such that control of delivery of media content to a client device of a passenger for whom a passenger parameter is sensed is based on the sensed passenger parameter. In examples, the sensed passenger parameter may also be provided to an on-board crew management terminal for use by transport craft crew. Further still, the sensed passenger parameter may be communicated to a ground system for use in control of a communication network providing media content to the craft. In addition, the passenger parameter may also be used for real-time billing or other purposes.

### FIELD

The present disclosure generally relates to communication systems for mobile transport craft. More particularly, the present disclosure relates to delivery and control of media content for a mobile transport craft

### BACKGROUND

It is becoming increasingly common for users to desire to consume streaming media while in transit (e.g., on mobile devices, like mobile phones, laptop computers, tablet computers, integrated media terminals, or other in-transport terminals), for example while in airplanes, busses, cruise ships, or other transport craft. Such media consumption can be very data-intensive and can place large burdens on resources of communications networks used to deliver communications services to the transport craft. For example, when many passengers desire to consume streaming media on board an aircraft, there may be insufficient network capacity (e.g., via a satellite network link to the aircraft) to provide all the desired media to all those passengers' devices.

Conventionally, many transport service providers seek to address this concern by storing media content local to (i.e., on-board) the transport craft, and allowing passengers only to access the on-board content. For example, the passengers can consume television programs, movies, and/or other types of media content through wired and/or wireless networks on-board the transport craft, without using any network capacity to stream the media from off-board sources. In some such approaches, passengers can only use off-board network capacity for lower-data applications (e.g., email, text messaging, etc.). In other such approaches, passengers are disincentivized from using off-board network capacity, for example, by being charged a fee; or only certain classes of passenger are provided with off-board network access. While such approaches can help minimize the amount of off-board network capacity being used by passengers, such approaches tend to appreciably limit passenger access to off-board media content. As such, conventional approaches often strike a poor balance between minimizing network resource usage and maximizing customer satisfaction.

### SUMMARY

Examples in the present disclosure provide techniques for control of an on-board content management system (CMS) based on a passenger parameter sensed by a wireless access point (WAP) on-board a transport craft. The passenger parameter is generated with sensing provided by analysis of transmitted and received communication signals from the WAP. Examples of a passenger parameter may include a passenger presence, a passenger gesture, one or more passenger health parameters, or passenger demographic data. In turn, the passenger presence may be used to control the on-board CMS to, for example, initiate or halt the delivery of media content to a client device associated with a passenger for whom the passenger parameter is sensed. Accordingly, resources such as network bandwidth, power, or other resources dedicated to providing and presenting the media content to the passenger may be conserved or otherwise managed in view of the passenger parameter sensed by the WAP.

According to one example, an on-board media system is provided that is disposed on a transport craft. The on-board media system provides content management based on a sensed passenger parameter. The system includes a network access point disposed on the transport craft that senses a passenger parameter related to a passenger aboard the transport craft. The passenger is associated with a client device for receipt and playback of media content on the client device for consumption by the passenger. The system also includes an on-board network interface system disposed on the transport craft to communicate, via an on-board communications network, with a plurality of client devices on the transport craft associated with a respective plurality of passengers aboard the transport craft including the client device of the passenger. An on-board content management system (CMS) is provided that is operative to communicate with the client device via the on-board network interface system to deliver the media content to the client device. The on-board CMS receives the passenger parameter and controls the media content based on the passenger parameter.

According to another embodiment, a method for operation of an on-board media system disposed on a transport craft for content management based on a sensed passenger parameter is provided. The method includes sensing a passenger parameter for a passenger aboard the transport craft by a network access point disposed on the transport craft and associating the passenger with a client device for receipt and playback of media content on the client device. The method also includes communicating via an on-board communications network with a plurality of client devices on the transport craft associated with a respective plurality of passengers aboard the transport craft including the client device of the passenger. The method further includes controlling the media content provided to the client device based on the passenger parameter.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

The accompanying drawings, referred to herein and constituting a part hereof, illustrate embodiments of the disclosure. The drawings together with the description serve to explain the principles of the invention.

FIG. 1 shows a simplified diagram of an example satellite communications system, which provides a context for various embodiments;

FIG. 2 shows an example environment in which one or more network access devices may employ sensing to generate one or more passenger parameters;

FIG. 3 shows a simplified diagram of a portion of a communications system having an off-board network in communication with on-board networks via one or more intermediary networks, according to various embodiments;

FIG. 4 shows an example of a portion of a passenger cabin of a transport craft in which wireless access points are employed to determine a passenger parameter for control of an on-board CMS.

FIG. 5 illustrates example operations for management of the delivery of content to a client device based on sensed passenger parameters.

FIG. 6 illustrates an exemplary implementation of a computing system.

### DETAILED DESCRIPTION

In the following description, numerous specific details are provided for a thorough understanding of the present invention. However, it should be appreciated by those of skill in the art that the present invention may be realized without one or more of these details. In other examples, features and techniques known in the art will not be described for purposes of brevity.

The present disclosure generally relates sensing passengers on board a transport craft for use in relation to delivery of content to passengers. Specifically, the present disclosure may utilize sensing capabilities of a network access point to detect one or more passenger parameters regarding a given passenger for use in relation to the control of a content management system (CMS) on-board the transport craft. In one example, the network access point may employ an IEEE 802.11 protocol (e.g., IEEE 802.11bf or other IEEE 802.11 protocol that provides sensing capability) that facilitates sensing capabilities that may generally be referred to as Wi-Fi sensing. In this regard, network access points provided on-board a transport craft may be utilized both to deliver a wireless communication network for delivery of media content to a plurality of client devices on-board the transport craft while also sensing one or more passenger parameters for passengers aboard the transport craft.

A passenger parameter sensed by a network access point on-board the transport craft may be provided to an on-board CMS to provide feedback for control of the CMS. The passenger parameter may provide information to the CMS regarding one or more of a passenger presence, a passenger gesture, one or more passenger health parameters, or passenger demographic data. In turn, the experience of a given passenger or a collection of passengers may be improved by providing feedback control of the CMS based on one or more sensed passenger parameters. As an example, delivery of media content may be initiated or halted in response to detecting the presence or absence of a given passenger. In turn, network resources may be conserved by avoiding delivery of media content to client devices that are not being utilized due to an absence of an associated passenger, the passenger having fallen asleep, or other information. Further still, the sensed passenger parameter may comprise demographic information that may be used to tailor the media content provided to a passenger. For instance, age-appropriate content may be provided to passengers that are detected to be children.

In other examples, sensed passenger parameters detected by network access points on-board the transport device may also be leveraged for other potential uses. As will be discussed in greater detail below, such uses may relate to providing passenger parameter data to an on-board crew management terminal to allow for transport craft crew members to appropriately react to passengers based on the sensed passenger parameters. Examples may include sensing of a passenger gesture to summon crew members for assistance or sensing of health information that may alert crew members to a medical emergency or the like. In other examples, the passenger parameters may be communicated to other communication network components for control of the communication network, billing purposes, analytics, or to provide alerts to ground systems or other network components. As an example, a number of sensed passengers consuming media content may be used to determine communication network resources allocated to a given transport craft.

In turn, the use of network access points to sense one or more passenger parameters may provide valuable information that may be used for feedback control of an on-board CMS. With improved control of the CMS system, system resources may be more efficiently utilized, which may lead to an increase in passenger satisfaction related to the consumption of media data. Further advantages may also be provided to provide increased care to passengers requiring assistance. Still further, by detecting passenger parameters in real time to provide indications of usage of the CMS, a communication network operator or CMS provider may be provided with real-time or near real-time analysis of network usage for control of network resources and associated billing.

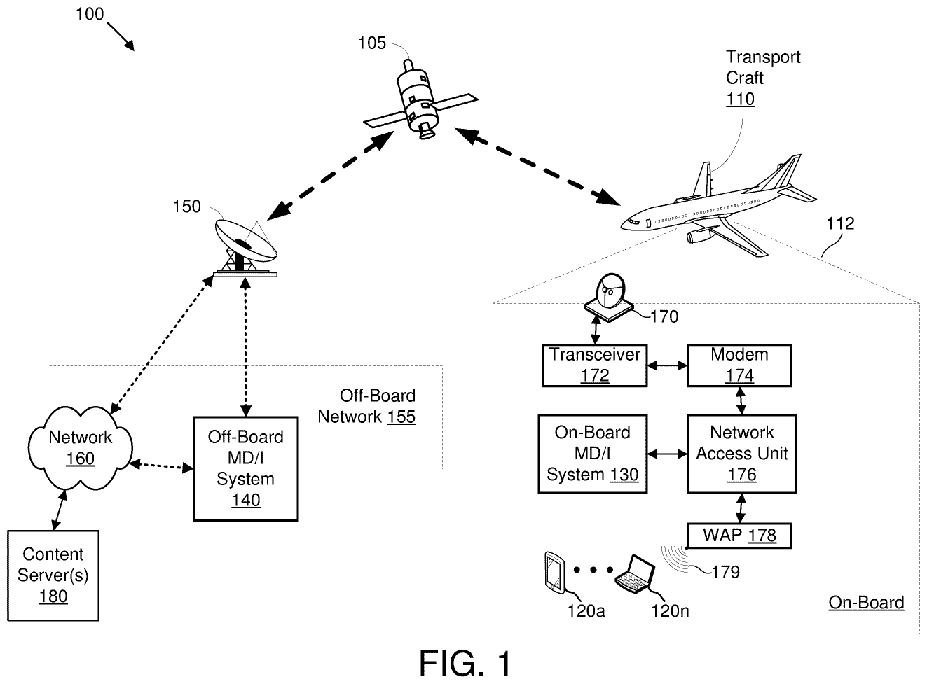

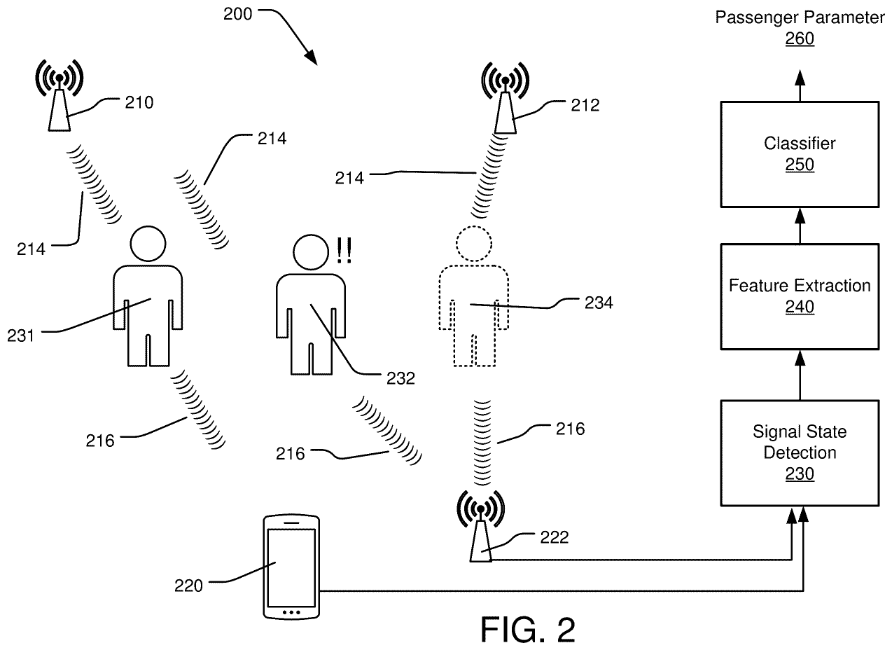

FIG. 1 shows a simplified diagram of an example satellite communications system 100, which provides a context for various embodiments described herein. Many other configurations are possible having more or fewer components than the satellite communications system 100 of FIG. 1. In the illustrated example, the satellite communications system 100 is being used to provide communications services between an off-board network 155 and one or more transport craft 110 (e.g., for delivery of streamed media content or other data communications to the transport craft 110). For example, the transport craft(s) 110 can include airplanes, trains, buses, cruise ships, etc.; and any or all such transport craft(s) 110 can communicate via any one or more suitable communications architecture(s) including any suitable communications links, such as satellite communications systems, air-to-ground communication systems, hybrid satellite and air-to-ground communications systems, cellular communications systems, etc. Further, while illustrated as a satellite communications system, examples can operate in context of cellular communications systems, and/or any other suitable long-range wireless communications system. For example, as described with reference to FIG. 2 below, portions of the illustrated satellite communications system 100 (e.g., the satellite 105 and the gateway 150) can be one illustrative implementation of one or more intermediary networks that provide connectivity between the off-board network 155 and one or more transport craft 110 (and/or client devices 120 disposed thereon).

Each transport craft 110 can be used to transport one or more passengers, and the satellite communications system 100 can be used to deliver media content to the passengers on board the transport craft 110. Passengers can consume media while on board the transport craft 110 using any suitable type of client device 120. Some client devices 120 can include personal mobile devices, such as smart phones, laptop computers, tablet computers, and the like. Other client devices can include devices installed in the transport craft 110, such as seat-back media displays, shared cabin media displays, and the like. Using the client devices 120, passengers can access a graphical user interface that includes a media channel interface. The media channel interface graphically presents a number of media channel offerings to the passengers. By interacting with the media channel interface (e.g., by interacting with a touchscreen interface, a peripheral input/output device, a remote control, and/or any other user interface associated with a client device 120) a passenger can select any of the media channel offerings for viewing. The media channel offerings can include streamed media channel offerings and pre-positioned media channel offerings. Streamed media channel offerings generally include any media channel offerings being streamed to the transport craft 110, which can provide broadcast television content, on-demand media content (e.g., movies, television episodes, music videos, sports footage, etc.), dedicated media streams, and/or any other suitable content. The term “streamed” is used herein to refer to any suitable manner of communicating a media channel offering to the transport craft 110 via a network external to the transport craft 110 and concurrently with the media channel offering being consumed by one or more passengers, as opposed to the media channel offering being served from storage on-board the transport craft 110. Pre-positioned media channel offerings generally include those served from storage on-board the transport craft 110 (i.e., pre-positioned on the transport craft 110), which can include content segments (e.g., stored movies, television episodes, music videos, sports footage, trailers, advertisements, etc.), and/or any other suitable content.

The streamed media channel offerings can originate from one or more content servers 180. For example, the transport craft 110 can be in communication with an off-board network 155 via a satellite 105 and a gateway 150, and the off-board network 155 can include (or can be in communication with) the content server(s) 180 via one or more content network(s) 160 (e.g., the Internet). The gateway 150 can include, and/or be in communication with, an off-board media delivery and interface (MD/I) system 140. For example, the gateway 150 can be in direct communication with the off-board MD/I system 140, or in communication with the off-board MD/I system 140 via one or more networks (e.g., content network(s) 160). Nodes of the off-board network 155 can be in communication via any suitable types of networks and/or network links, such as the Internet, an IP network, an intranet, a wide area network (WAN), a local area network (LAN), a virtual private network (VPN), a virtual LAN (VLAN), a fiber optic network, a cable network, a public switched telephone network (PSTN), a public switched data network (PSDN), a public land mobile network, and/or any other type of network having wired and/or wireless (e.g., including optical) communications links.

As described herein, features of various examples can be enabled by interactions between the off-board MD/I system 140 and an on-board MD/I system 130 disposed on the transport craft 110. Embodiments of the off-board MD/I system 140 and the on-board MD/I system 130 can include any suitable components, such as one or more media servers, media storage devices, etc. Functions and features of the off-board MD/I system 140 and the on-board MD/I system 130 can be implemented in hardware, instructions embodied in memory and formatted to be executed by one or more general or application-specific processors, firmware, or any combination thereof.

The on-board MD/I system 130 can be part of a two-way communication system 112 disposed on the transport craft 110 to facilitate bidirectional communication with the satellite 105. In the illustrated embodiment, the two-way communication system 112 also includes an antenna system 170, transceiver 172, modem 174, network access unit 176, and wireless access point (WAP) 178. The two-way communication system 112 can provide for reception of a forward downlink signal from the satellite 105 and transmission of a return uplink signal to the satellite 105 to support two-way data communications between the client devices 120 within the transport craft 110 and nodes of the off-board network 155 (e.g., the off-board MD/I system 140, the content server(s) 180, etc.). In addition to providing communications between the transport craft 110 and the satellite 105, the two-way communication system 112 can also facilitate communications with the client devices 120. For example, the client devices 120 can communicate with the network access unit 176 via a one or more on-board communication links 179, which can include any suitable wired and/or wireless communications links (e.g., and any other supporting components, such as logical and/or physical ports, etc.). The on-board communication links 179 can be, for example, part of a local area network such as a wireless local area network (WLAN) support by WAP 178. One or more WAPs 178 can be distributed about the transport craft 110, and can, in conjunction with network access unit 176, provide traffic switching and routing functionality; for example, as part of a WLAN extended service set (ESS), etc.

In operation, the network access unit 176 can provide uplink data received from the client devices 120 to the modem 174 to generate modulated uplink data (e.g., a transmit intermediate frequency (IF) signal) for delivery to the transceiver 172. The transceiver 172 can upconvert and amplify the modulated uplink data to generate the return uplink signal for transmission to the satellite 105 via the antenna system 170. Similarly, the transceiver 172 can receive the forward downlink signal from the satellite 105 via the antenna system 170. The transceiver 172 can amplify and downconvert the forward downlink signal to generate modulated downlink data (e.g., a receive IF signal) for demodulation by the modem 174. The demodulated downlink data from the modem 174 can be provided to the network access unit 176 for routing to the client devices 120. The various components of the two-way communication system 112 can be implemented in any suitable manner. For example, while shown as separate components, some or all components can be integrated into a single component (e.g., modem 174 can be integrated with network access unit 176) or segmented into additional components.

As described in more detail below, the on-board MD/I system 130 and/or the off-board MD/I system 140 can provide commands to the network access unit 176 to manage and distribute media channel offerings and to handle related media channel interface commands, with regard to the passengers' client devices 120. As further described in more detail below, the management of the distribution of media channel offerings and/or control of one or more client devices may be at least in part based on sensed passenger parameters detected by the WAP(s) 178. For example, it can be desirable to provide a highly satisfying media consumption experience for passengers by offering passengers a large variety of media options (or, at least, a reasonable number of highly relevant options), which can involve making a large variety of media channel offerings available for streaming to the client devices 120 on board the transport craft 110. However, concurrently streaming a large number of media channel offerings to the transport craft can consume an appreciable amount of bandwidth and/or other resources of the satellite communications system 100 (and/or other intermediary networks) servicing the transport craft 110. Accordingly, embodiments seek to maintain a high level of (and even increase) passenger satisfaction with the on-board media consumption experience, while reducing the amount of network capacity being used to provide the on-board media consumption experience. At least to that end, examples provide techniques for controlling the delivery of media channel offerings to passengers based on sensed passenger parameters.

Specifically, the examples provided herein may utilize sensing of one or more passenger parameters that can be used to control the on-board MD/I system 130. For example, one or more sensors may be disposed at or within the transport craft 110. The one or more sensors may facilitate sensing of one or more passenger parameters. In an example, a network access point such as the WAP(s) 178 may comprise sensing functionality to determine a passenger parameter of one or more passengers on board the transport craft 110. As noted above, the transport craft 110 may include a plurality of WAPs 178, which may be distributed about the transport craft 110. The WAPs 178 may coordinate to provide sensing of passenger parameters. Alternatively, a given WAP 178 may monitor one or more passengers in the vicinity of the given WAP 178 to provide passenger parameters for those passengers in the vicinity of the given WAP 178. In an example, the WAP 178 may implement an IEEE 802.11 protocol for providing sensing of one or more passengers on board the transport craft 110.

With further reference to FIG. 2, an environment 200 that may be monitored using Wi-Fi sensing to detect a passenger parameter 260 is shown. The environment 200 may include a plurality of wireless access points including access point 210, access point 212, and access point 222. In addition, one or more client devices 220 may also be utilized. In the environment 200, one or more of the access points including access point 210 and access point 212 may generate a transmitted Wi-Fi signal 214. In turn, received Wi-Fi signals 216 may be received by another access point 222 and/or a client device 220.

As the transmitted Wi-Fi signals 214 traverse the environment 200, the characteristic of the transmitted Wi-Fi signal 214 may be altered prior to being received as received Wi-Fi signal 216. For instance, the transmitted Wi-Fi signals 214 may be altered by one or more passengers in the environment 200. As an example, passenger presence such as the presence of passenger 231 may be detected. In addition, passenger health monitoring may be utilized to detect one or more passenger health parameters of an ailing passenger 232. Also, passenger demographic data regarding passenger 231 or passenger 232 may be generated. Furthermore, the absence of a passenger 234 may also be detected such as the lack of a passenger in a designated passenger area such as a seat or the like.

The detection of the passenger characteristics described above may be provided by utilizing signal state detection of the received Wi-Fi signals 216. That is, information regarding the received Wi-Fi signals 216 may be provided by the receiving devices such as the client device 220 and the network access point 222. Detected states of the received Wi-Fi signals 216 may include detection of phase shifts, frequency shifts, Doppler shifts, amplification shifts, signal time-of-flight, or other signal states related to changes in the received Wi-Fi signals 216 relative to the transmitted Wi-Fi signals 214. The signal state information may be detected by a signal state detection module 230. Upon detection of signal state information, the signal state information may be provided to a feature extraction module 240. The feature extraction module 240 may utilize the signal state information to identify features from the signal state information. In turn, the features may be extracted based on the signal state information. Data regarding the extracted features may be provided to a classifier module 250. The classifier module 250 may employ an algorithmic approach to provide classification including classifications of passenger presence, human activity recognition (e.g., gesture detection), passenger health parameters, or passenger demographic detection. In turn, the classifier module 250 may output one or more passenger parameters 260 that may provide descriptive information regarding one or more of the passenger 231, the passenger 232, or an absence of a passenger 234. The signal state detection module 230, feature extraction module 240, and/or classifier module 250 may be provided on-board the transport craft. In an example, the signal state detection module 230, feature extraction module 240, and/or classifier module 250 may be incorporated with a network access point 222 or an onboard MD/I system 130 (as described in relation to FIG. 1).

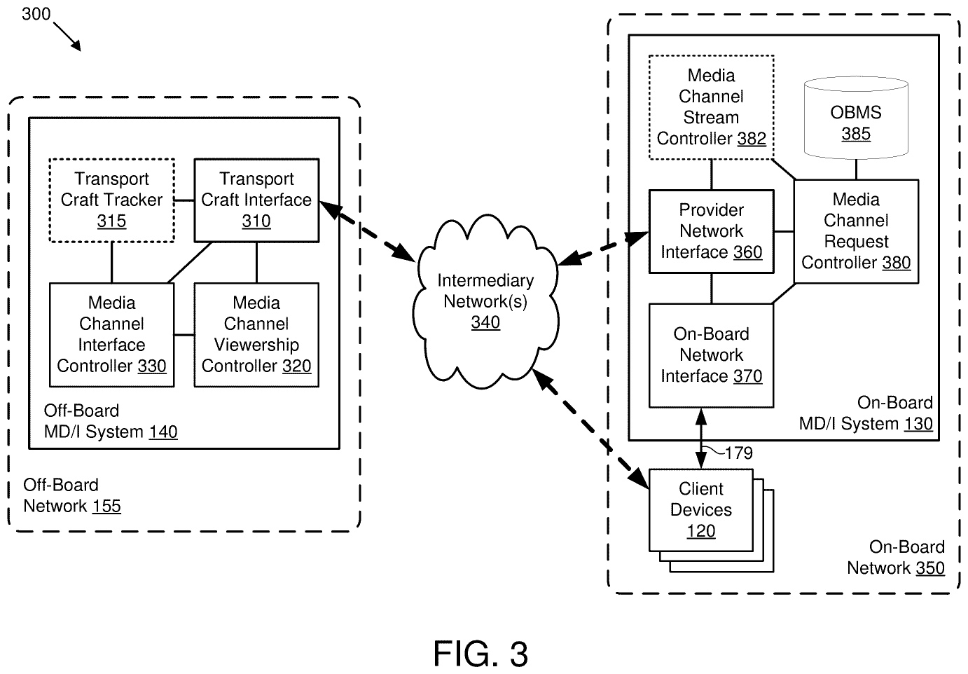

FIG. 3 shows a simplified diagram of a portion of an example of a communications system 300 having an off-board network 155 in communication with on-board networks 350 via one or more intermediary networks 340. The communications system 300 can be an implementation of the communications system 100 described with reference to FIG. 1. The one or more intermediary networks 340 can include any suitable communications links and architectures, such as any suitable wired and/or wireless links, public and/or private networks, etc. Typically, because of the mobile nature of the transport craft 110, the one or more intermediary networks 340 will likely involve at least one long-range wireless communications link. The at least one long-range wireless communications link can include one or more satellite communications links (e.g., as shown in FIG. 1), one or more cellular communications links, and/or any other suitable wireless communications link(s). Such wireless links can be generally referred to as “carriers,” which can operate in any suitable one or more frequencies, phases, polarizations, etc.; which may or may not overlap. In one implementation, the one or more intermediary networks 340 include a multi-carrier satellite communications network that serves a large service area made up of multiple spot beam coverage areas. In such a multi-carrier communications network, as the transport craft 110 moves through the communications network, it can move through multiple carrier coverage areas; so that communications services can be provided to the transport craft 110 (and/or to client devices 120 on board the transport craft 110) via different carriers over time. For example, during a transatlantic or international airplane flight, the airplane, and the client devices 120 of passengers on the airplane, may move through a number of carrier coverage areas, and the different carriers servicing those coverage areas can be used over time to maintain communications with the transport craft 110 over a large geographic region covered during transport (e.g., the traversed region is larger than a single carrier coverage area), and/or to provide other features, such as facilitating load balancing across multiple carriers, grouping of terminals by carrier, etc.

Each on-board network 350 is disposed in a transport craft 110 (e.g., as shown in FIG. 1), and a single transport craft 110 can have more than one on-board network 350 disposed thereon. Each on-board network 350 can include at least one on-board MD/I system 130 by which to provide media services (e.g., and other communications services in some cases) to some or all of the client devices 120 of passengers on board the transport craft 110. Some implementations of the on-board network 350 facilitate connectivity between the client devices 120 and the intermediary network(s) 340 via components of the on-board MD/I system 130 via one or more on-board communication links 179 (e.g., wired and/or wireless links). Additionally or alternatively, some implementations of the on-board network 350 facilitate connectivity between the client devices 120 and the intermediary network(s) 340 without passing through components of the on-board MD/I system 130 (e.g., the client devices 120 are in communication with the intermediary network(s) 340 via the WAP 178, network access unit 176, modem 174, transceiver 172, and antenna system 170 of FIG. 1). Accordingly, for the sake of simplicity, the client devices 120 and the on-board MD/I system 130 are both shown as part of the on-board network 350.

The off-board network 155 can include any suitable components disposed in any suitable location or locations; such that the off-board network 155 is remote from the transport craft 110, but able to be in communication with the on-board networks 350 of the transport craft 110. The off-board network 155 can include at least one off-board MD/I system 140 by which to provide media services (e.g., and other communications services in some cases) to some or all of the transport craft 110. Though not shown, embodiments of the off-board network 155 can include, and/or be in communication with, one or more content servers 180 (e.g., via one or more content networks 160). As described with reference to FIG. 1, some implementations of the off-board network 155 facilitate connectivity between the content servers 180 and the intermediary network(s) 340 via components of the off-board MD/I system 140. Additionally or alternatively, some implementations of the off-board network 155 facilitate connectivity between the content servers 180 and the intermediary network(s) 340 without passing through components of the off-board MD/I system 140 (e.g., some or all of the content servers 180 are in communication with the intermediary network(s) 340 via the content networks 160 of FIG. 1).

As noted above, features of various embodiments can be enabled by interactions between the off-board MD/I system 140 and the on-board MD/I systems 130 disposed on the transport craft 110. The off-board MD/I system 140 can include a transport craft interface 310, a media channel viewership controller 320, and a media channel interface controller 330. Embodiments of the transport craft interface 310 can facilitate communications between the off-board MD/I system 140 and the intermediary networks 340, thereby also facilitating communications between the off-board MD/I system 140 and client devices 120 on board the transport craft 110. The transport craft interface 310 can include any suitable components for communicatively interfacing with the intermediary networks 340, such as one or more antennas, transceivers, amplifiers, filters, switches, routers, wired and/or wireless ports, components to implement one or more communications protocols, etc.

Embodiments of the media channel viewership controller 320 can be communicatively coupled with the transport craft interface 310 to receive media viewership signals from the client devices 120. The media viewership signals can be received from the client devices 120 and/or from the on-board MD/I system 130. The media viewership signals can indicate viewership, by the client devices 120, of the multiple media channel offerings that are selectable for viewing via adaptive on-board media channel interfaces displayable on each of the client devices 120. For example, when a passenger desires to view media while on board the transport craft 110, the passenger can use a client device 120 (e.g., a personal device, such as a smart phone, laptop computer, tablet computer, etc.; or a provided device, such as a seat-back media display) to access one or more media channel interfaces. The media channel interfaces can graphically display a listing of available media channel offerings that can be selected by the passenger via the interface (e.g., by interacting with a touchscreen interface). In one implementation, the media channel interface includes an array of icons, each representing a selectable media channel offering. In another implementation, the media channel interface includes a grid-type listing of available media channel offerings (e.g., similar to an electronic program guide). In another implementation, the media channel interface includes a text-only listing of available media channel offerings. In some implementations, the media channel interface can include additional navigation features, such as interface controls (e.g., virtual touchscreen buttons) for sorting displayed media channel offerings, filtering displayed media channel offerings, categorizing media channel offerings (e.g., using tabs, sub-menus, etc.), etc.

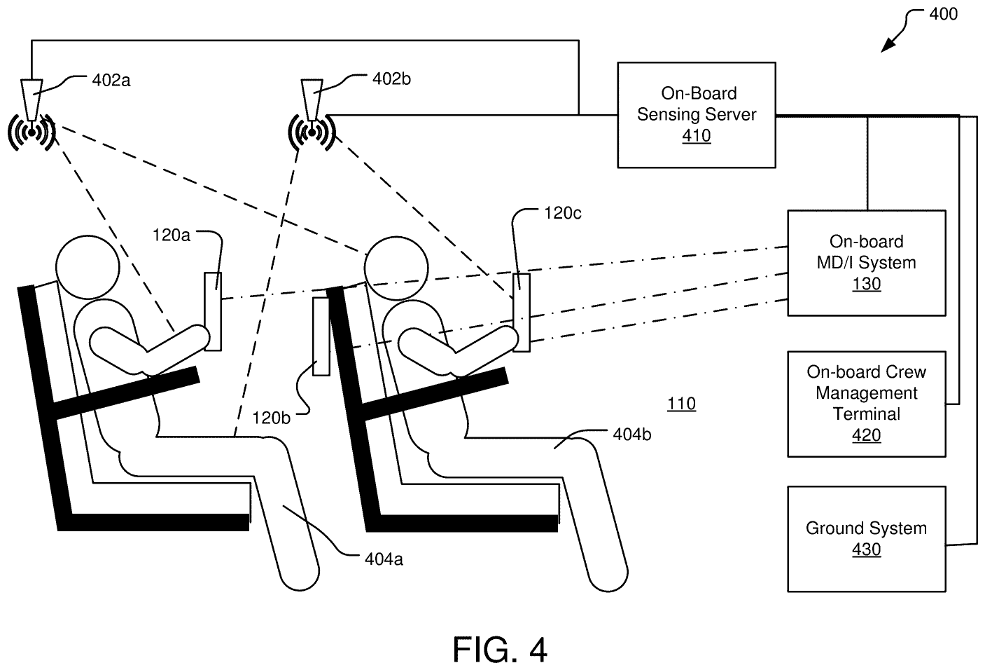

FIG. 4 illustrates an example environment 400 in which sensing one or more passenger parameters may be used to provide feedback for control of media content to one or more client devices. A passenger 404a and a passenger 404b are shown on board a transport craft 110. It may be appreciated that the principals of operation described for the environment 400 may be extended to fewer or additional passengers 404 without limitation. Passenger 404a may be associated with one or more client device such as client device 120a and client device 120b. In this example, client device 120a may be a personal device of passenger 404a that may be brought on board by the passenger 404a. Alternatively, client device 120a may be provided to passenger 404a upon boarding the transport craft 110. Client device 120b may be a seat-back device positioned relative to a seat of passenger 404a such that passenger 404a may view and interact with the client device 120b. Passenger 404b may be associated with a client device 120c.

The transport craft 110 may include a WAP 402a and a WAP 402b disposed in the cabin of the transport craft 110. As noted above, WAP 402a and WAP 402b may be configured to provide monitoring of passenger 404a and/or passenger 404b. WAP 402a and/or WAP 402b may be provided with a protocol for sensing one or more passenger parameters for passenger 404a and/or passenger 404b.

In turn, WAP 402a and WAP 402b may be in operative communication with an on-board sensing server 410 which may include a signal state detection module 230, a feature extraction module 240, and/or a classifier module 250 as described above for use in detecting signal states of transmitted wireless signals for use in determine a passenger parameter. WAP 402a and/or WAP 402b may provide a signal to the on-board sensing server 410 for generation of a passenger parameter for passenger 404a and/or passenger 404b. In this regard, the WAPs 402 may process measured signals to determine a passenger parameter or may pass measured signal information to the on-board sensing server 410, which may process the measured signal information into one or more passenger parameters.

The on-board sensing server 410 may be in further operative communication with an on-board MD/I system 130. As shown in FIG. 4, the on-board MD/I system 130 may communicate with the client device 120a, client device 120b, and/or client device 120c to provide media content to the respective client devices 120. As will be discussed in greater detail below, the provision or control of media content to the client devices 120 may be at least in part based on sensed passenger parameters for the passenger 404 associated with a given client device 120.

The passenger parameter may include one or more informational items related to, for example, a passenger presence, a passenger gesture, one or more passenger health parameters, or passenger demographic data. In relation to a passenger presence, the WAPs 402 may be able to discern whether passenger 404a is located in a seat associated with the passenger 404a. Thus, the passenger parameter may include an indicator of passenger presence based on whether a passenger 404 is present in a given location (e.g., an assigned seat for the passenger 404) or whether a passenger 404 is not present in a given location. Furthermore, the passenger presence parameter may include a location of a passenger 404 within the transport craft 110. For instance, designated areas may be provided within the transport craft 110 such that a passenger's presence in an area may be designated by the passenger presence parameter. Such designated areas may include an assigned seat for a passenger 404, a lounge area, a lavatory, a common area, an area in which passengers are not permitted, or other designated area defined relative to the transport craft.

The passenger parameter may also include monitoring of a passenger 404 for one or more passenger gestures. For example, a passenger 404 may raise their hand, which may be detected by processing signals from the WAP 402a and/or WAP 402b at the on-board sensing server 410. Such a gesture may indicate a passenger 404 is requesting assistance from the crew of the transport craft 110. Other gestures, including those associated with control of playback of media content at a client device 120 may also be monitored. A passenger gesture may also certain movements of the passenger such as standing, bending at the waist, head movements, arm movements, leg movements, or other activities of the passenger.

The passenger parameter may also include one or more passenger health parameters. For instance, the WAP 402a and/or the WAP 402b may monitor passenger 404a and/or passenger 404b for heart rate, respiratory rate, temperature, blood pressure or other health related parameters.

The passenger parameter may also include demographic data of the passenger. For instance, a size of the passenger 404 may be determined to estimate an age of the passenger 404. Further still, a passenger's gender may be identified as passenger demographic data.

A passenger parameter may be utilized to provide information regarding a given passenger 404 on board the transport craft 110 or collective passenger parameters for a plurality of passengers 404 may be provided. In the foregoing instance, information such as the presence of the given passenger 404, a gesture of the given passenger 404, or health parameters of a given passenger 404 may allow for feedback or control of transport craft systems specific to the given passenger 404. However, in other instances, the collective passenger parameters may also be provided to provide characterizations or actions based on the passenger parameters for a plurality of passengers. Accordingly, the collective passenger parameters regarding a plurality of passengers 404 may include an indication of a number of total passengers on board the transport craft 110, a number of awake passengers 404 at any given time, collective demographics data for the passengers on board a transport craft 110, or other collective data that describes or characterizes a plurality of passengers without specific regard to any single one of the passengers.

As noted above, the on-board sensing server 410 may be in operative communication with an on-board MD/I system 130. Thus, control of the MD/I system 130 may be at least in part based on one or more passenger parameters sensed for the transport craft 110. For instance, media content delivery to a given client device 120 may be initiated and/or halted based on a passenger parameter for a passenger 404 associated with the client device 120. As an example, passenger 404a may leave their assigned seat to move to another area of the transport craft 110 such as a lounge area or a lavatory. In turn, by halting or deactivating delivery of media content to a client device for a passenger whose passenger parameter indicates the passenger is not actively consuming the media content, the total network resources dedicated to transmitting the media data may be conserved. Moreover, in the context of a client device 120b comprising a seat-back device positioned relative to a seat of passenger 404a, a passenger parameter for passenger 404a that is indicative of the passenger not consuming media data (e.g., the passenger has left their seat or fallen asleep) the client device 120b may be deactivated or powered off to conserve energy consumption as well.

Control of the MD/I system 130 may also be at least in part based on demographic data of a passenger parameter. For instance, a passenger age may be estimated based on the passenger parameter information. In turn, age-appropriate media content may be provided to a passenger that is suspected to be a child based on the sensed demographic data. For instance, explicit media may be restricted from delivery to a client device associated with a passenger suspected to be a child based on the sensed passenger parameter of that passenger. In other examples, sensed passenger demographic data may be used to tailor content presented to a passenger such as by highlighting content in a user interface for a given passenger.

The on-board sensing server 410 may also be in operative communication with an on-board crew management terminal 420 and/or a ground system 430. In relation to the ground system 430, the on-board sensing server 410 may provide data to the modem 174 and transceiver 172 as shown in FIG. 1 for communication of passenger parameter data via a satellite communication system 100 or other communication link of the transport craft 110. In the case of the on-board crew management terminal 420, a passenger parameter may be provided to alert the crew of the transport craft 110 to a passenger activity or need. Examples may include passing a passenger parameter comprising a passenger gesture to the on-board crew management terminal 420 to signal a passenger calling for assistance of the crew. Other examples include the on-board crew management terminal 420 providing a warning to the crew of the transport craft 110 based on a passenger parameter (e.g., based on a passenger health parameter indicating a passenger 404 requires medical attention, a passenger parameter indicating that a passenger 404 is in an unauthorized area, a passenger parameter indicating that a passenger 404 is not complying with safety regulations, etc.).

In addition, the ground system 430 may receive one or more passenger parameters. Such ground system 430 may include a portion of a control segment of one or more communication links for the transport craft 110. As such, the control segment may control a configuration of the communication link based on one or more passenger parameter. For instance, a collective passenger parameter indicating a total number of passengers on board a transport craft 110 may be provided to the control segment for use in tailoring one or more of the communication links based on the number of passengers and, correspondingly, an anticipated bandwidth requirement for the passengers on board. That is, a network allocation of a communication network delivering content to the transport craft may be based on one or more passenger parameters received from a transport craft.

Additionally or alternatively, the ground system 430 may include an invoicing module that may be used to provide real-time feedback (i.e., during a given passage of a transport craft 110) of a number of passengers on board the transport craft 110 to forecast invoicing and/or revenue projections, which may be based on a number of passengers on board or a utilization figure for one or more of the communication links.

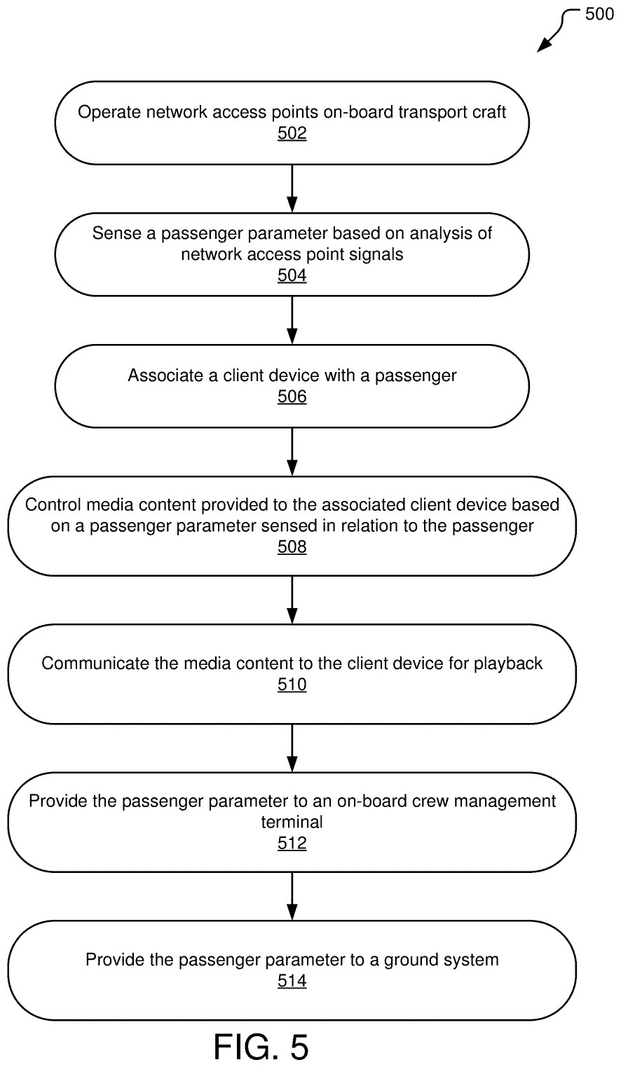

FIG. 5 depicts example operations 500 for use of a sensed passenger parameter to control an onboard content management system (CMS). Example operations 500 include an operating operation 502 in which network access points (e.g., wireless access points) are operated on-board the transport craft. The wireless access points may communicate wirelessly with devices on-board or off-board the transport craft. For instance, the wireless access points may employ and IEEE 802.11 protocol that allows for Wi-Fi sensing based on the signals transmitted from and received by the wireless access points. The operating operation 502 may include active data communications between a device and the wireless access points or may include transmission of signals between the wireless access points without communication of any data to a device other than the wireless access points.

In any regard, the wireless access points on-board the transport craft may generate transmitted and received signals. In this regard, changes to the signal between the transmission and reception of the signal may provide some indication of a sensed parameter in relation to an environment through which the signal was transmitted. Accordingly, the example operations 500 may include a sensing operation 504 in which the signals transmitted and received by the wireless access points are analyzed to sense at least one passenger parameter. As described in detail above, the sensed passenger parameter may relate to a passenger presence, a passenger gesture, one or more passenger health parameters, passenger demographic data, or other characteristics associated with passenger that may be sensed based on analysis of the signals from the wireless access points.

The example operations 500 may also include an associating operation 506 in which a client device is associated with a given passenger. The associating operation 506 may include registering a client devices to a specific passenger. This associating operation 506 may be based on information relating the client device with the passenger. For example, in the event that the client device is a seatback device, a passenger may be associated with the respective seatback device based on a seat assignment of the passenger. Alternatively, in the event that the client device is a device brought on-board by the passenger, the associating operation 506 may include registering the client device with a given passenger using a login or other authorization form. As may be appreciated, the associating operation 506 may allow specific control or delivery of media content to the client device associated with a passenger. Furthermore, a passenger parameter may also be detected for that the passenger such that the client device associated with the passenger may be controlled based on the passenger parameter for the associated passenger.

The example operations 500 may also include a controlling operation 508 in which the media content provided to the associated client device of a passenger is controlled based on the passenger parameter sensed for the passenger. That is, the media content delivered to a client device may be controlled based on the sensed passenger parameter for the passenger associated with the client device. For instance, a seatback device may be initialized such that media content may begin to be delivered to the seatback device upon determining that a passenger is present in the seat associated with the seatback device. Furthermore, in the event the passenger were to leave the seat (e.g., to utilize the lavatory or to move about the cabin of the transport device), content delivery to the client device may be ceased during the absence of the passenger. Further still, in the event that the passenger parameter indicates that the passenger has fallen asleep, the delivery of media content may also be paused or ceased to the client device associated with the passenger. This may allow for efficient utilization of the bandwidth of the transport craft in both receiving media content from an offboard content source as well as efficient utilization of bandwidth of the on-board communication system. Specifically, communications to client devices for which no passenger has been detected or for which a passenger has been detected as being asleep may be halted such that network and/or power resources associate that client device may be conserved.

The example operations 500 may also include a communicating operation 510 in which media content is communicated to the client device for playback. For instance, the sensed passenger parameter may indicate that the passenger is present, awake, and available to consume media. In response, the communicating operation 510 may commence to provide media content to the client device for consumption by the passenger.

The example operations 500 may also include a providing operation 512 in which the passenger parameter may be provided to an on-board crew management terminal. This may allow the crew of the transport craft to monitor specific passenger parameters associated with passengers on-board the transport craft. As an example, in the event that a passenger suffers a health emergency, the health parameters of the passenger may be sensed as a passenger parameter that is communicated to the on-board crew management terminal to alert the crew members of the transport craft that the passenger is experiencing a medical issue. Furthermore, in the event a passenger becomes agitated, this may also be sensed and provided as a passenger parameter to the on-board crew management terminal to allow the crew to appropriately address the passenger. Other examples such as controlling the cabin climate controls or other crew managed activities may also be facilitated in response to the passenger parameters provided to the on-board crew management terminal. For instance, in one example, the sensing of the passenger parameter may include recognition of a passenger gesture. Accordingly, a passenger may gesture to request assistance from the crew. The gesture may be sensed and provided as a passenger parameter associated with the passenger to the on-board crew management terminal. This may alert the crew and allow crew members to assist the passenger in response to their gesture. Furthermore, compliance with crew instruction such as remaining seated, wearing a seatbelt, or other activities may be monitored such that in the event that a passenger does not comply with a given crew instruction, the crew may be alerted based on a sensed passenger parameter provided to the on-board crew management terminal.

The example operations 500 may further include a providing operation 514 in which the passenger parameter is provided to a ground system. In this regard, the providing operation 514 may include communicating the passenger parameter to the ground system using a communication system of the transport craft. Once received at the ground system, the passenger parameter may be utilized in a number of different aspects. For instance, as the passenger parameter may include indications of passenger presence, the passenger parameters for a given transport craft may indicate a number of passengers aboard the transport craft. This information may be provided to the ground system for real-time billing or invoicing based on number of passengers aboard transport craft. By real-time, it is meant that billing information may be generated substantially within the time the transport craft is in transit.

Furthermore, the communication system of the transport craft may be controlled based on the passenger parameters provided to the ground system. For instance, because the number of passengers aboard the transport craft may be provided to the ground system, the capacity of the communication system providing communications to the transport craft may be adjusted based on the sensed number of passenger aboard. As an example, in a satellite communication system, the available satellite beam capacity within a given satellite beam may be adjusted based on the number of passengers detected by the network access points on-board the aircraft. In this regard, based on the knowledge of the number of passengers aboard, the beam capacity allocated to provide communications to the transport craft may be adjusted depending upon a beam capacity allocation strategy such that an appropriate amount of network resources are associated to the transport craft based on the sensed number of passengers aboard the craft.

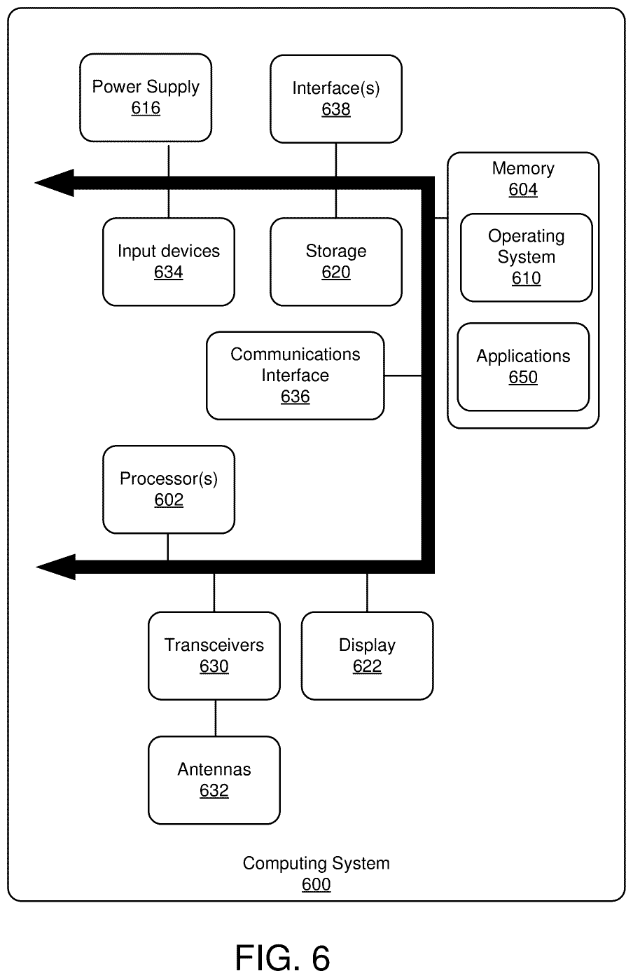

FIG. 6 illustrates an exemplary implementation of a computing system 600 for implementing the features and operations of the described technology. The computing system 600 may embody a remote-control device or a physical controlled device and is an example network-connected and/or network-capable device and may be a passenger/client device, such as a laptop, mobile device, desktop, tablet; a server/cloud device; an internet-of-things device; an electronic accessory; or another electronic device. The computing system 600 includes one or more processor(s) 602 and a memory 604. The memory 604 generally includes both volatile memory (e.g., RAM) and nonvolatile memory (e.g., flash memory). An operating system 610 resides in the memory 604 and is executed by the processor(s) 602. The computing system 600 may be an implementation of one or more of an off-board CMS, on-board systems, an on-board CMS, a signal state detector, a feature extraction module, a classifier, an on-board crew management terminal, a ground system, an on-board sensing server, a network access unit, a WAP, an on-board media system, a passenger/client device, an off-board communication network, and any of systems 100-400.

In an example computing system 600, as shown in FIG. 6, one or more modules or segments, such as applications 650, an on-board CMS, an off-board CMS, a signal state detector, a feature extraction module, a classifier, an on-board crew management terminal, a ground system, or an on-board sensing server are loaded into the operating system 610 on the memory 604 and/or storage 620 and executed by processor(s) 602. The storage 620 may include one or more tangible storage media devices and may store one or more passenger parameters or other data and be local to the computing system 600 or may be remote and communicatively connected to the computing system 600.

The computing system 600 includes a power supply 616, which is powered by one or more batteries or other power sources and which provides power to other components of the computing system 600. The power supply 616 may also be connected to an external power source that overrides or recharges the built-in batteries or other power sources.

The computing system 600 may include one or more communication transceivers 630, which may be connected to one or more antenna(s) 632 to provide network connectivity (e.g., mobile phone network, Wi-Fi®, Bluetooth®) to one or more other servers and/or passenger/client devices (e.g., mobile devices, desktop computers, or laptop computers). The computing system 600 may further include a network adapter 636, which is a type of computing system. The computing system 600 may use the adapter and any other types of computing systems for establishing connections over a wide-area network (WAN) or local-area network (LAN). It should be appreciated that the network connections shown are examples and that other computing systems and means for establishing a communications link between the computing system 600 and other devices may be used.

The computing system 600 may include one or more input devices 634 such that a user may enter commands and information (e.g., a keyboard or mouse). These and other input devices may be coupled to the server by one or more interfaces 638, such as a serial port interface, parallel port, or universal serial bus (USB). The computing system 600 may further include a display 622, such as a touch screen display.

The computing system 600 may include a variety of tangible processor-readable storage media and intangible processor-readable communication signals. Tangible processor-readable storage can be embodied by any available media that can be accessed by the computing system 600 and includes both volatile and nonvolatile storage media, removable and non-removable storage media. Tangible processor-readable storage media excludes communications signals (e.g., signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing system 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Various software components described herein are executable by one or more processors, which may include logic machines configured to execute hardware or firmware instructions. For example, the processors may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Aspects of processors and storage may be integrated together into one or more hardware logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of a remote-control device and/or a physically controlled device implemented to perform a particular function. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service,” as used herein, is an application program executable across one or multiple user sessions. A service may be available to one or more system components, programs, and/or other services. In some implementations, a service may run on one or more server computing systems.

The logical operations making up implementations of the technology described herein may be referred to variously as operations, steps, objects, or modules. Furthermore, it should be understood that logical operations may be performed in any order, adding or omitting operations as desired, regardless of whether operations are labeled or identified as optional, unless explicitly claimed otherwise or a specific order is inherently necessitated by the claim language.

One general aspect of the present disclosure includes an on-board media system disposed on a transport craft with content management based on a sensed passenger parameter. The system includes a network access point disposed on the transport craft that senses a passenger parameter related to a passenger aboard the transport craft. The passenger is associated with a client device for receipt and playback of media content on the client device for consumption by the passenger. The system also includes an on-board network interface system disposed on the transport craft to communicate, via an on-board communications network, with a plurality of client devices on the transport craft associated with a respective plurality of passengers aboard the transport craft including the client device of the passenger. The system also includes an on-board content management system (CMS) operative to communicate with the client device via the on-board network interface system to deliver the media content to the client device. The on-board CMS receives the passenger parameter and controls the media content based on the passenger parameter.

Implementations may include one or more of the following features. For example, the passenger parameter may include at least one of a passenger presence, a passenger gesture, one or more passenger health parameters, or passenger demographic data.

In an example, the on-board CMS may be operative to control the delivery of the media content by at least one of initiating or halting the delivery of the media content to the client device based on the passenger parameter. For example, the passenger parameter may include an indication of passenger presence. In turn, the on-board CMS may be operative to initiate the delivery of the media content to the client device when the passenger parameter indicates the passenger is present and to halt the delivery of the media content to the client device when the passenger parameter indicates the passenger is not present.

In other examples, the on-board CMS may be operative to identify media content available for delivery to the client device based on the passenger parameter. The passenger parameter may include demographic data for the passenger. In turn, the media content available for delivery to the client may be selected based on the demographic data for the passenger.

In an example, the system may also include a passenger parameter system operative to receive data from the network access point related to the passenger parameter. The passenger parameter system may process the passenger parameter for communication of the passenger parameter to the on-board CMS. For example, the passenger parameter system may associate the passenger parameter with the passenger. In addition, the passenger may be associated with the client device such that the on-board CMS provides control of media content to the client device based on the passenger parameter for the passenger associated with the client device.

In an example, the passenger parameter system may be operative to store collective passenger parameters for a plurality of passengers. The passenger parameter system may be operative to communicate the collective passenger parameters from the transport craft in real time. In one example, the collective passenger parameters may be received at a ground terminal for real-time control of at least one communication link for communication of data between the transport craft and a gateway. Additionally or alternatively, the collective passenger parameters may provide real-time feedback to a ground terminal regarding CMS usage on the transport craft (e.g., for billing, invoicing, or other record keeping purpose). In still further examples, the CMS may be operative to control media content play back to the plurality of client devices based on the collective passenger parameters.

In an example, the passenger parameter system may provide the passenger parameter to an on-board crew management terminal that provides transport craft crew information regarding the passenger. For example, the passenger parameter may indicate a request for assistance of the transport craft crew. In this regard, the on-board crew management terminal may be operative to provide the transport craft crew an alert regarding the passenger based on the passenger parameter.

In an example, the network access point may utilize an IEEE 802.11 protocol to sense the passenger parameter.

Another general aspect of the present disclosure includes a method for operation of an on-board media system disposed on a transport craft for content management based on a sensed passenger parameter. The method includes sensing a passenger parameter for a passenger aboard the transport craft by a network access point disposed on the transport craft. The method also includes associating the passenger with a client device for receipt and playback of media content on the client device. The method includes communicating via an on-board communications network with a plurality of client devices on the transport craft associated with a respective plurality of passengers aboard the transport craft including the client device of the passenger. The method also includes controlling the media content provided to the client device based on the passenger parameter.

Implementations may include one or more of the following features. For example, the passenger parameter may include at least one of a passenger presence, a passenger gesture, one or more passenger health parameters, or passenger demographic data.

In an example, the controlling the media content may include at least one of initiating or halting delivery of the media content to the client device based on the passenger parameter. For example, the passenger parameter may include an indication of passenger presence and the method may further include initiating delivery of the media content to the client device when the passenger parameter indicates the passenger is present and halting delivery of the media content to the client device when the passenger parameter indicates the passenger is not present.

In an example, the method may also include identifying media content available for delivery to the client device based on the passenger parameter. In this regard, the passenger parameter may include demographic data for the passenger. In turn, the media content available for delivery to the client may be identified based on the demographic data for the passenger.

In an example, the method may include providing data from the network access point related to the passenger parameter to a passenger parameter system. In addition, the method may include processing the data related to the passenger parameter for communication of the passenger parameter to an on-board content management system (CMS). The method may also include associating the passenger parameter with the passenger and the client device such that the on-board CMS provides control of media content to the client device based on the passenger parameter for the passenger associated with the client device.

In an example, the method may include storing collective passenger parameters for a plurality of passengers. In addition, the method may include communicating the collective passenger parameters from the transport craft in real time. The collective passenger parameters may be received at a ground terminal for real-time control of at least one communication link for communication of data between the transport craft and a gateway. For example, the collective passenger parameters may provide real-time feedback to a ground terminal regarding content usage on the transport craft. In this regard, the method may also include controlling media content playback to the plurality of client devices based on the collective passenger parameters.

In an example, the method may include providing the passenger parameter to an on-board crew management terminal that provides transport craft crew information regarding the passenger. For example, the passenger parameter may indicate a request for assistance of the transport craft crew. The method may include providing the transport craft crew an alert regarding the passenger based on the passenger parameter.

In an example, the network access point may utilize an IEEE 802.11 protocol to sense the passenger parameter.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the described technology have been described. Nevertheless, it will be understood that various modifications can be made without departing from the spirit and scope of the recited claims.

1. An on-board media system disposed on a transport craft with content management based on a sensed passenger parameter, comprising:
a network access point disposed on the transport craft that senses a passenger parameter related to a passenger aboard the transport craft, the passenger being associated with a client device for receipt and playback of media content on the client device for consumption by the passenger;
an on-board network interface system disposed on the transport craft to communicate, via an on-board communications network, with a plurality of client devices on the transport craft associated with a respective plurality of passengers aboard the transport craft including the client device of the passenger; and
an on-board content management system (CMS) operative to communicate with the client device via the on-board network interface system to deliver the media content to the client device, wherein the on-board CMS receives the passenger parameter and controls the media content based on the passenger parameter.

2. The on-board media system of claim 1, wherein the passenger parameter comprises at least one of a passenger presence, a passenger gesture, one or more passenger health parameters, or passenger demographic data.

3. The on-board media system of claim 1, wherein the on-board CMS is operative to control the delivery of the media content by at least one of initiating or halting the delivery of the media content to the client device based on the passenger parameter.

4. The on-board media system of claim 1, wherein the passenger parameter comprises an indication of passenger presence, and wherein the on-board CMS is operative to initiate the delivery of the media content to the client device when the passenger parameter indicates the passenger is present and to halt the delivery of the media content to the client device when the passenger parameter indicates the passenger is not present.

5. The on-board media system of claim 1, wherein the on-board CMS is operative to identify media content available for delivery to the client device based on the passenger parameter.

6. The on-board media system of claim 1, wherein the passenger parameter comprises demographic data for the passenger, and wherein the media content available for delivery to the client is selected based on the demographic data for the passenger.

7. The on-board media system of claim 1, further comprising:
a passenger parameter system operative to receive data from the network access point related to the passenger parameter, wherein the passenger parameter system processes the passenger parameter for communication of the passenger parameter to the on-board CMS.

8. The on-board media system of claim 1, wherein the passenger parameter system associates the passenger parameter with the passenger, and wherein the passenger is associated with the client device such that the on-board CMS provides control of media content to the client device based on the passenger parameter for the passenger associated with the client device.

9. The on-board media system of claim 1, wherein the passenger parameter system is operative to store collective passenger parameters for a plurality of passengers.

10. The on-board media system of claim 9, wherein the passenger parameter system is operative to communicate the collective passenger parameters from the transport craft in real time.

11. The on-board media system of claim 9, wherein the collective passenger parameters are received at a ground terminal for real-time control of at least one communication link for communication of data between the transport craft and a gateway.

12. The on-board media system of claim 9, wherein the collective passenger parameters provide real-time feedback to a ground terminal regarding CMS usage on the transport craft.

13. The on-board media system of claim 9, wherein the CMS is operative to control media content play back to the plurality of client devices based on the collective passenger parameters.

14. The on-board media system of claim 1, wherein the passenger parameter system provides the passenger parameter to an on-board crew management terminal that provides transport craft crew information regarding the passenger.

15. The on-board media system of claim 1, wherein the passenger parameter indicates a request for assistance of the transport craft crew.

16. The on-board media system of claim 1, wherein the on-board crew management terminal is operative to provide the transport craft crew an alert regarding the passenger based on the passenger parameter.

17. The on-board media system of claim 1, wherein the network access point comprises an IEEE 802.11 protocol to sense the passenger parameter.

18. A method for operation of an on-board media system disposed on a transport craft for content management based on a sensed passenger parameter, comprising:
sensing a passenger parameter for a passenger aboard the transport craft by a network access point disposed on the transport craft;
associating the passenger with a client device for receipt and playback of media content on the client device;
communicating via an on-board communications network with a plurality of client devices on the transport craft associated with a respective plurality of passengers aboard the transport craft including the client device of the passenger; and
controlling the media content provided to the client device based on the passenger parameter.

19. The method of claim 18, wherein the passenger parameter comprises at least one of a passenger presence, a passenger gesture, one or more passenger health parameters, or passenger demographic data.

20. The method of claim 18, wherein the controlling the media content comprises at least one of initiating or halting delivery of the media content to the client device based on the passenger parameter.

21. The method of claim 18, wherein the passenger parameter comprises an indication of passenger presence, and wherein the method further comprises:
initiating delivery of the media content to the client device when the passenger parameter indicates the passenger is present; and
halting delivery of the media content to the client device when the passenger parameter indicates the passenger is not present.

22. The method of claim 18, wherein further comprising:
identifying media content available for delivery to the client device based on the passenger parameter.

23. The method of claim 18, wherein the passenger parameter comprises demographic data for the passenger, and wherein the media content available for delivery to the client is identified based on the demographic data for the passenger.

24. The method of claim 18, further comprising:
providing data from the network access point related to the passenger parameter to a passenger parameter system; and
processing the data related to the passenger parameter for communication of the passenger parameter to an on-board content management system (CMS).

25. The method of claim 18, further comprising:
associating the passenger parameter with the passenger and the client device such that the on-board CMS provides control of media content to the client device based on the passenger parameter for the passenger associated with the client device.

26. The method of claim 18, further comprising:
storing collective passenger parameters for a plurality of passengers.

27. The method of claim 26, further comprising:
communicating the collective passenger parameters from the transport craft in real time.

28. The method of claim 26, wherein the collective passenger parameters are received at a ground terminal for real-time control of at least one communication link for communication of data between the transport craft and a gateway.

29. The method of claim 26, wherein the collective passenger parameters provide real-time feedback to a ground terminal regarding content usage on the transport craft.

30. The method of claim 26, further comprising:
controlling media content playback to the plurality of client devices based on the collective passenger parameters.

31. The method of claim 18, further comprising:
providing the passenger parameter to an on-board crew management terminal that provides transport craft crew information regarding the passenger.

32. The method of claim 18, wherein the passenger parameter indicates a request for assistance of the transport craft crew.

33. The method of claim 18, further comprising:
providing the transport craft crew an alert regarding the passenger based on the passenger parameter.

34. The method of claim 18, wherein the network access point comprises an IEEE 802.11 protocol to sense the passenger parameter.
